(19) United States
(12) Patent Application Publication
(10) Pub. No.: US 2007/0294467 A1
(43) Pub. Date: Dec. 20, 2007

(54) Multi-Channel Flash Memory Data Access Method

(76) Inventor: Kwok-Yan Leung, Willowdale (CA)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/425,367

(22) Filed: Jun. 20, 2006

(51) Int. Cl. G06F 12/00

(52) U.S. Cl. 711/103

(57) ABSTRACT

A multi-channel flash memory data access method is disclosed herein. Firstly, a predetermined number of communication channels are established between a plurality of flash memories and a flash memory controller. Since each of the respective communication channels may be used to transmit a single byte of data. As such, in transmitting a predetermined number of bytes of data synchronously through the predetermined number of communication channels, data can be transmitted to the host as it is done by a hard disk drive, as long as the amount of data accumulated reaches the nominal value of one sector.

### BACKGROUND OF THE INVENTION

1. Field of the Invention

The present invention relates to a flash memory data access method, and in particular to a multi-channel flash memory data access method.

2. The Prior Arts

In general, hard disk drive is utilized as the storage device for storing large amount of data and information in a computer system. With the rapid progress and development of hard disk drive manufacturing technology, the price and capacity of hard disk drive have reached a rather mature and satisfactory level. However, in the process of data processing, the read/write head of the hard disk drive is certain to make physical contacts with magnetic disk platter actually storing the data. As such, the magnetic disk platter is liable to be damaged, and the data stored therein will likewise be rendered useless accordingly. In addition, in a hard disk drive, motor capable of making high speed rotations is utilized to drive the magnetic disk platter. Consequently, the power consumption is always a problem. This is especially true for the portable computer device (such as the notebook computer) having stringent power consumption requirements.

In order to solve the afore-mentioned problem of the prior art, the design without having to use motor consuming large amount of power and without the read/write head contacting disk platter problem seems to be a good solution. For this reason, the non-volatile memory is used to replace the magnetic disk platter, and serves as a large capacity storage device used for actually storing data. In this respect, in the non-volatile memory, the flash memory and the related technology are the most mature and advanced. Therefore, quite a lot of manufacturers are engaging in manufacturing large capacity storage device such as hard disk drive having IDE interface.

Though the storage device made of flash memory has the advantage of not having to use a power consuming motor, and a disk platter damaging read/write head. However, the problem caused by its intrinsic property has still to be solved. In this respect, the problem is that, in general, the flash memory is composed of a plurality of transistor memory cells, and its data access is realized through the Fowler-Nordheim tunneling to achieve data storage or erase. However, in this process of data access, large amount current flows through a dielectric layer at the side of floating gate (FG) of the transistor memory cell. For this reason, the transistor memory cells tend to fail or malfunction after certain number times of write/erase operations. Though this problem begins to surface only after a few hundred-thousand to million times of write/erase operations, yet for the research and development of the storage device made of flash memory, the problem as to how to reduce the number of write/erase operations while still achieving the objective of data access, thus prolonging the service life of such kind of storage device, is probably the most important problem that has to be solved in this field.

In addition to reducing the number of write/access operations of the flash memory, another problem of equal concern is the read/write speed. Presently, for the storage device made of flash memory, data is read at the speed of a byte a time, and data is transmitted to the host computer only when the accumulated read out data has reached a sector (namely 512 bytes). As such, compared with the data read/write speed of the hard disk drive, the performance of the afore-mentioned data storage device made of flash memory has left much to be desired.

### SUMMARY OF THE INVENTION

In view of the shortcomings and drawbacks of the prior art, the objective of the present invention is to provide a data access method for a multi-channel flash memory Wherein, the data access speed and efficiency of data storage device made of flash memory can be improved significantly by making use of the multi-channel in synchronism.

Based on the above description, the essence of the multi-channel flash memory data access method of the present invention is that, a predetermined number of communication channels are established between a plurality of flash memories and flash memory controllers. Since each of the plurality of communication channels may be used to transmit only a single byte of data, thus, if a predetermined number of communication channels are utilized to transmit a predetermined number of bytes of data in synchronism, the flash memory data storage device may perform the data transmission to the host computer in the same manner as the hard disk drive, when the accumulated data amount reaches the nominal value of a sector.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a multi-channel flash memory structure used in the data access method according to an embodiment of the present invention; and

FIG. 2 is a schematic diagram of communication channels connecting the flash memory and the flash memory controller according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

In the following illustrations, the multi-channel flash memory data access method of the present invention will be described in detail with reference to the attached drawings.

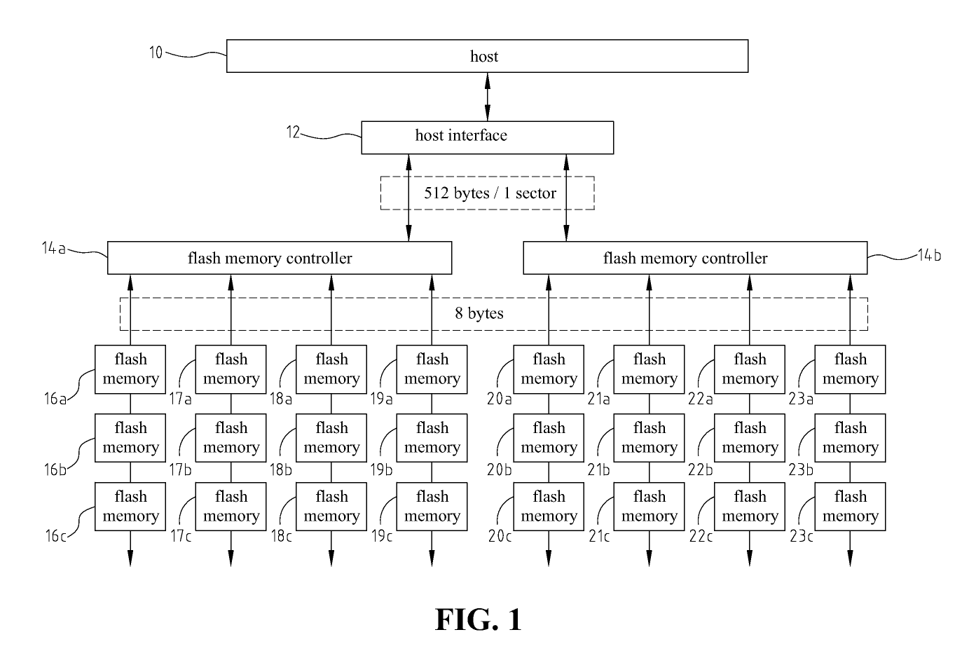

Firstly, referring to FIG. 1 for a schematic diagram of multi-channel flash memory structure used in the data access method according to an embodiment of the present invention. As shown in FIG. 1, firstly, eight predetermined communication channels are established between eight columns of flash memories 16a-16c, 17a-17c, 18a-18c, 19a-19c, 20a-20c, 21a-21c, 22a-22c, 23a-23c and flash memory controllers 14a, 14b. In this case, as it is in the prior art, in each of the respective channels, only one byte of data may be access at one time. However, in practice, the number of communication channels is not restricted to eight as shown in FIG. 1, and thus it may range from 2 to 512. Likewise, the number of flash memory controllers 14a and 14b may not subject to too many restrictions. Usually, the more flash memory controllers are provided, the faster the data access can be achieved for each of the respective channels.

In brief, the essence of the multi-channel flash memory data access method of the present invention is to replace the hard disk by making use of the flash memory data storage device, thus the host interface 12, and flash memory controllers 14a and 14b are utilized to proceed with the special data exchange and processing required, so that though the data access is performed relative to the flash memories 16a-16c, 17a-17c, 18a-18c, 19a-19c, 20a-20c, 21a-21c, 22a-22c, and 23a-23c, however, to the host 10, it may not discern any difference from the conventional data access of the hard disk.

To be more specific, in the afore-mentioned data processing and exchange, the unit of data access is still a sector (512 bytes) as is in the case for hard disk. In this manner, upon accumulating up to 256 bytes of data (256×2=512), the buffer areas built in the flash memory controllers 14a and 14b are utilized to transmit a sector of data to the host 10 via the host interface 12.

In the implementation of data access, the flash memory controller 14a fetches simultaneously from flash memories 16a-16c, 17a-17c, 18a-18c, and 19a-19c one byte of data each for a total of 4-byte data; meanwhile, likewise, the flash memory controller 14b fetches simultaneously from flash memories 20a-20c, 21a-21c, 22a-22c, and 23a-23c one byte of data each for a total of 4-byte data. Therefore, as shown in FIG. 1, with the configuration of eight communication channels, the flash memory controllers 14a and 14b may fetch 8 bytes of data in each data access, so that 1 sector of data can be accessed in 64 data accesses. That is quite an improvement over the prior art, wherein 512 accesses are required to access a sector of data. As such, the multi-channel flash memory data access method of the present invention may be used to raise the data access efficiency significantly. Furthermore, if the number of the communication channels is increased, then the number of accesses required to access each sector of data may further be reduced, thus further raising the access efficiency of the multi-channel flash memory data access method.

Moreover, the host interface 12 shown in FIG. 1 can be a device selected from the group consisting of: small computer system interface (SCSI), fiber channel interface (FC), peripheral component interconnect (PCI), flash memory card interface; serial storage architecture (SSA), integrated drive electronics (IDE), universal serial bus (USB), IEEE 1394, personal computer memory card international association (PCMCIA) interface, serial ATA (SATA), parallel ATA (PATA), and other appropriate bus interfaces.

Similar to the design of a hard disk drive, in the storage device utilized in the multi-channel flash memory data access method of the present invention, an allocation table is provided respectively in the flash memory controllers 14a and 14b, that is equivalent to the File Allocation Table (FAT) used in the hard disk. Though this single communication channel technology belongs to the prior art, yet it will be described briefly in the following in conjunction with the allocation table for better understanding of the implementation of the present invention.

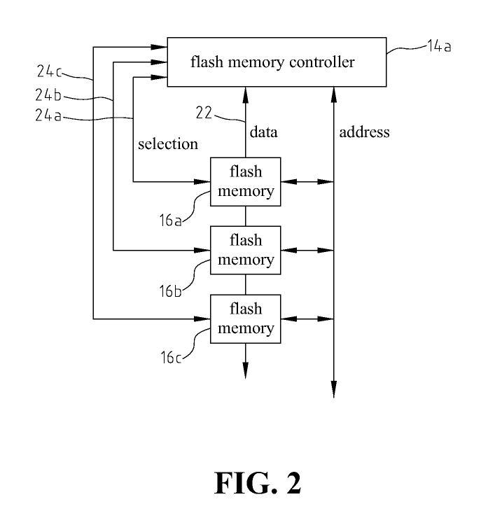

Referring to FIG. 2 for a schematic diagram of the communication channels connecting the flash memory and the flash memory controller according to an embodiment of the present invention. As shown in FIG. 2, each of the respective communication channels is composed of an address line 21, a data line 22, and selection lines 24a to 24c, connected electrically to the corresponding flash memories 16a to 16c and the flash memory controller 14a. For example, in case it is known from the allocation table that the data to be accessed is at a first address of the flash memory 16b, the address is selected via the address line 21 and the selection line 24b, and the data access is realized via the data line 22.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements that are within the scope of the appended claims.

What is claimed is:

1. A multi-channel flash memory data access method, comprising the steps of:
establishing each of a predetermined number of communication channels between each of a plurality of flash memories and a flash memory controller, each communication channel is capable of transmitting a single byte of data;
transmitting synchronously a predetermined number of bytes of data utilizing said predetermined number of said communication channels; and
when the data fetched synchronously from the corresponding flash memories reaches the nominal value of 1 sector, transmitting the data to the host.

2. The multi-channel flash memory data access method as claimed in claim 1, wherein said sector has a nominal value of 512 bytes.

3. The multi-channel flash memory data access method as claimed in claim 1, wherein each of said communication channels is electrically connected to said corresponding flash memory and said flash memory controller through an address line, a data line and a selection line.

4. The multi-channel flash memory data access method as claimed in claim 1, wherein the data communication is capable of being realized between said flash memory controller and said host through a host interface.

5. The multi-channel flash memory data access method as claimed in claim 1, wherein said host interface is an interface selected from the group consisting of: small computer system interface (SCSI), fiber channel interface (FC), peripheral component interconnect (PCI), flash memory card interface, serial storage architecture (SSA), integrated drive electronics (IDE), universal serial bus (USB), IEEE 1394, personal computer memory card international association (PCMCIA) interface, serial ATA (SATA), parallel ATA (PATA), and other appropriate bus interfaces.

6. A multi-channel flash memory data access method, comprising the steps of:
establishing each of a predetermined number of communication channels between each of a plurality of flash memories and a flash memory controller, each communication channel is capable of transmitting a single byte of data;
obtaining a sector of data from a host; and
transmitting synchronously a predetermined number of bytes of data to said corresponding flash memory through said predetermined number of said communication channels.

7. The multi-channel flash memory data access method as claimed in claim 6, wherein the nominal value of said sector is 512 bytes.

8. The multi-channel flash memory data access method as claimed in claim 6, wherein each of said communication channels is electrically connected to said corresponding flash memory and said flash memory controller through an address line, a data line and a selection line.

9. The multi-channel flash memory data access method as claimed in claim 6, wherein the data communication is capable of being realized between said flash memory controller and said host through a host interface.

10. The multi-channel flash memory data access method as claimed in claim 6, wherein said host interface is selected from the following devices comprising the group of: small computer system interface (SCSI), fiber channel interface (FC), peripheral component interconnect (PCI), flash memory card interface; serial storage architecture (SSA), integrated drive electronics (IDE), universal serial bus (USB), IEEE 1394, personal computer memory card international association (PCMCIA) interface, serial ATA (SATA), parallel ATA (PATA), and other appropriate bus interfaces.
